(19) United States
(12) Patent Application Publication
(10) Pub. No.: US 2012/0238205 A1
(43) Pub. Date: Sep. 20, 2012

(54) METHOD, APPARATUS AND A COMPUTER PROGRAM FOR OUT-OF-BAND SHORT-RANGE COMMUNICATION CARRIER TRANSPORT SWITCHING

(75) Inventors: Jukka Reunamäki, Tampere (FI); Arto Palin, Viiala (FI)

(73) Assignee: Nokia Corporation, Espoo (FI)

(21) Appl. No.: 13/049,429

(22) Filed: Mar. 16, 2011

(51) Int. Cl. H04B 5/00; H04B 7/00

(52) U.S. Cl. 455/41.1; 455/41.2

(57) ABSTRACT

Example method, apparatus, and computer program product embodiments are disclosed to enable out-of-band short-range communication carrier transport switching for connection setup of in-band device-to-device communication. Example embodiments of the invention include a method comprising the steps of transmitting, by a first device via an out-of-band short-range communication carrier, an indication to a second device that a carrier switch from the out-of-band short-range communication carrier to an in-band short-range communication carrier is desired; receiving in response to the transmitted indication, a response from the second device via the out-of-band short-range communication carrier including an indication that the carrier switch from the out-of-band short-range communication carrier to the in-band short-range communication carrier is confirmed; and modifying, by the first device, device detection procedure associated with the in-band short-range communication carrier to improve detection of paging signals on the in-band short-range communication carrier.

### FIELD

The field of the invention relates to wireless communication, and more particularly to out-of-band short-range communication carrier transport switching for connection setup in device-to-device communication.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed second generation (2G) digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology that has quickly gained acceptance in the marketplace. In addition to Bluetooth™ other popular short-range communication technologies include Bluetooth™ Low Energy, IEEE 802.11 wireless local area network (WLAN), Wireless Universal Serial Bus (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

Near field communication technologies, such s radio frequency identification (RFID) technologies, comprise a range of RF transmission systems, for example standardized and proprietary systems for a variety of different purposes, such as product tagging for inventory handling and logistics, theft prevention purposes at the point of sale, and product recycling at the end of the life-cycle of the tagged product. In addition to RFID technologies, Near Field Communication (NFC) technology has recently evolved from a combination of existing contactless identification and interconnection technologies. NFC is both a “read” and “write” technology. Communication between two NFC-compatible devices occurs when they are brought within close proximity of each other: A simple wave or touch can establish an NFC connection that is then compatible with other known wireless technologies, such as Bluetooth™ or wireless local area network (WLAN).

### SUMMARY

Method, apparatus, and computer program product embodiments are disclosed to enable out-of-band short-range communication carrier transport switching for faster connection setup of in-band device-to-device communication.

An example embodiment of the invention includes a method comprising the steps of:

transmitting, by a first device via an out-of-band short-range communication carrier, an indication to a second device that a carrier switch from the out-of-band short-range communication carrier to an in-band short-range communication carrier is desired;

receiving in response to the transmitted indication, a response from the second device via the out-of-band short-range communication carrier including an indication that the carrier switch from the out-of-band short-range communication carrier to the in-band short-range communication carrier is confirmed; and

modifying, by the first device, device detection procedure associated with the in-band short-range communication carrier to improve detection of paging signals on the in-band short-range communication carrier.

In an example embodiment of the invention the indication of a carrier switch to an in-band carrier includes in-band communication connection parameters to adjust a paging procedure in the second device.

In an example embodiment of the invention the device detection procedure associated with the in-band short-range communication carrier is modified by at least one of increasing a duration of a page scanning window and decreasing a duration of a page scanning interval.

In an example embodiment of the invention the out-of-band short-range carrier communication signals are based on one of Near Field Communication, Radio Frequency Identification, Infrared Data Association, or Ultra Wide Band communications protocol.

In an example embodiment of the invention the first and second devices use an NFC Forum connection handover protocol as the short-range carrier transport switch procedure for the carrier switch to an in-band Bluetooth carrier.

An example embodiment of the invention includes a method comprising the steps of:

receiving, by a second device, an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and

modifying, by the second device, device detection procedure associated with the in-band short-range communication carrier to improve detection of paging signals from the first device, in an in-band communication connection.

In an example embodiment of the invention, a computer program product comprising computer executable program code recorded on a computer readable storage medium, the computer executable program code, when executed by a computer processor, performing the steps in the example methods recited above.

In an example embodiment of the invention, an apparatus comprises:

at least one processor;

at least one memory including computer program code;

the at least one memory and the computer program code configured to, with the at least one processor, cause the apparatus at least to:

transmit via an out-of-band short-range communication carrier, an indication to a second device that a carrier switch from the out-of-band short-range communication carrier to an in-band short-range communication carrier is desired;

receive in response to the transmitted indication, a response from the second device via the out-of-band short-range communication carrier including an indication that the carrier switch from the out-of-band short-range communication carrier to the in-band short-range communication carrier is confirmed; and

modify device detection procedure associated with the in-band short-range communication carrier to improve detection of paging signals on the in-band short-range communication carrier.

In an example embodiment of the invention, an apparatus comprises:

at least one processor;

at least one memory including computer program code;

the at least one memory and the computer program code configured to, with the at least one processor, cause the apparatus at least to:

receive an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and

modify device detection procedure associated with the in-band short-range communication carrier to improve detection of paging signals from the first device, in an in-band communication connection.

An example embodiment of the invention includes a method comprising the steps of:

transmitting, by an apparatus, an indication to a near field communication module to initiate an in-band short-range communication connection with a wireless device, using a wireless in-band short-range communication module;

receiving, by the apparatus, from the near field communication module, in response to the transmitted indication, a response from the wireless device that the in-band short-range communication connection is acceptable; and

modifying, by the apparatus, device detection procedure associated with the wireless in-band short-range communication module to improve detection of paging signals by the wireless in-band short-range communication module.

An example embodiment of the invention includes a method comprising the steps of:

receiving, at an apparatus, an indication from a near field communication module to initiate short-range communication connection using a wireless short-range communication module; and

modifying, by the apparatus, device detection procedure associated with the wireless short-range communication module to improve detection of paging signals by the wireless short-range communication module.

An example embodiment of the invention includes a method further comprising determining by the apparatus, that the in-band short-range communication connection is acceptable before modifying the device detection procedure associated with the wireless short-range communication module.

In an example embodiment of the invention, a computer program product comprising computer executable program code recorded on a computer readable storage medium, the computer executable program code, when executed by a computer processor, performing the steps in the example methods recited above.

In an example embodiment of the invention, an apparatus comprises:

at least one processor;

at least one memory including computer program code;

the at least one memory and the computer program code configured to, with the at least one processor, cause the apparatus at least to:

transmit an indication to a near field communication module to initiate an in-band short-range communication connection with a wireless device, using a wireless in-band short-range communication module;

receive from the near field communication module, in response to the transmitted indication, a response from the wireless device that the in-band short-range communication connection is acceptable; and

modify device detection procedure associated with the wireless in-band short-range communication module to improve detection of paging signals by the wireless in-band short-range communication module.

In an example embodiment of the invention, an apparatus comprises:

at least one processor;

at least one memory including computer program code;

the at least one memory and the computer program code configured to, with the at least one processor, cause the apparatus at least to:

receive an indication from a near field communication module to initiate short-range communication connection using a wireless short-range communication module; and

modify device detection procedure associated with the wireless short-range communication module to improve detection of paging signals by the wireless short-range communication module.

In an example embodiment of the invention, an apparatus further comprises the at least one memory and the computer program code being further configured to, with the at least one processor, cause the apparatus at least to determine that the in-band short-range communication connection is acceptable before causing modifying the device detection procedure associated with the wireless short-range communication module.

The resulting embodiments enable out-of-band short-range communication carrier transport switching for faster connection setup in Bluetooth device-to-device communication.

### DESCRIPTION OF THE FIGURES

FIG. 1A is an example embodiment of a wireless network diagram of wireless device A and wireless device B, with device B initiating an out-of-band near-field communication connection with device A by transmitting wireless communication signals including necessary power for providing the out-of-band near-field communication connection and device B further sending in-band Bluetooth™ communication connection parameters including parameters indicating a Bluetooth™ connection handover procedure, to device A via the out-of-band near-field communication connection, according to an embodiment of the present invention.

FIG. 1B is an example embodiment of the wireless device A of FIG. 1A, illustrating the processor, NFC controller module, and Bluetooth™ radio module in the device A, shown with a superimposed diagram of the page scan intervals established by the Bluetooth™ Media Access Control (MAC) in the processor, the device A assuming the role of a potential slave in a potential piconet with device B, according to an embodiment of the present invention.

FIG. 1C is an example embodiment of the wireless device A of FIG. 1B, illustrating the processor as an integrated circuit chip that includes the NCI firmware, wherein the NCI firmware in the chip is connected to the near field (NFC) radio module, according to an embodiment of the present invention.

FIG. 1D is an example embodiment of the wireless device A of FIG. 1C, illustrating the processor as an integrated circuit chip that includes the NCI firmware and the near field (NFC) radio, according to an embodiment of the present invention.

FIG. 2A is an example embodiment NFC handover request RF frame from device B to device A of FIG. 1A, with parameters indicating a proposed Connection Handover as Bluetooth™, sent by the requesting device B over the NFC link, according to an embodiment of the present invention.

FIG. 2B is an example embodiment NFC handover select RF frame from responding device A to device B of FIG. 1A, with parameters indicating the acceptance by responding device A of the proposed Bluetooth™ Connection Handover, sent by the responding device A over the NFC link, according to an embodiment of the present invention.

FIG. 2C is an example embodiment NFC handover request RF frame from device B to device A of FIG. 1A, with parameters indicating a proposed Connection Handover as Bluetooth™ and an indication that the requesting device B will do the page scan, sent by the requesting device B over the NFC link, according to an embodiment of the present invention.

FIG. 2D is an example embodiment NFC handover select RF frame from responding device A to device B of FIG. 1A, with parameters indicating the acceptance by responding device A of the proposed Bluetooth™ Connection Handover and agreement to send the page, sent by the responding device A over the NFC link, according to an embodiment of the present invention.

FIG. 2E is an example embodiment showing the extraction by the NFC controller in device A of FIG. 1B, of the payload data from the NFC handover request RF frame received from device B, including parameters indicating a proposed Connection Handover as Bluetooth™, and insertion by the NFC controller of that payload data into an NCI data message that is forwarded to the processor of device A, according to an embodiment of the present invention.

FIG. 3A is an example flow diagram of operational steps of an example embodiment of the method carried out by requesting device B of FIG. 1A, where requesting device B modifies Bluetooth™ page scanning procedures for receiving paging signals in the in-band Bluetooth™ communication connection from the responding device A, according to an embodiment of the present invention.

FIG. 3B is an example flow diagram of operational steps of an example embodiment of the method carried out by responding device A of FIG. 1A, where responding device A sends Bluetooth™ paging signals in the in-band Bluetooth™ communication connection to the requesting device B, according to an embodiment of the present invention.

FIG. 3C is an example flow diagram of operational steps of an example embodiment of the method carried out by requesting device B of FIG. 1A, 1B, 1C, or 1D, where requesting device B modifies page scanning procedures for receiving paging signals in a generic in-band communication connection from the responding device A, in a generic in-band communication connection.

FIG. 3D is an example flow diagram of operational steps of an example embodiment of the method carried out by modular components of the requesting device B of FIG. 1A, 1B, or 1C, where requesting device B modifies page scanning procedures for receiving paging signals in a generic in-band communication connection from the responding device A, in a generic in-band communication connection.

FIG. 4A is an example embodiment NFC handover request record message format from device B to device A of FIG. 1A, with parameters indicating a proposed Connection Handover as Bluetooth™ and an indication that the responding device A should do the page scan, sent by the requesting device B over the NFC link, according to an embodiment of the present invention.

FIG. 4B is an example embodiment NFC handover select record message format from responding device A to device B of FIG. 1A, with parameters indicating the acceptance by responding device A of the proposed Bluetooth™ Connection Handover and agreement to do the page scan, sent by the responding device A over the NFC link, according to an embodiment of the present invention.

FIG. 5A is an example flow diagram of operational steps of an example embodiment of the method carried out by requesting device B of FIG. 1A, where requesting device B sends Bluetooth™ paging signals in the in-band Bluetooth™ communication connection to the responding device A, according to an embodiment of the present invention.

FIG. 5B is an example flow diagram of operational steps of an example embodiment of the method carried out by responding device A of FIG. 1A, where responding device A modifies Bluetooth™ page scanning procedures for receiving paging signals in the in-band Bluetooth™ communication connection from requesting device B, according to an embodiment of the present invention.

FIG. 5C is an example flow diagram 370 of operational steps of an example embodiment of the method carried out by responding device A of FIGS. 1A, 1B, 1C, and 1D in interacting with the requesting device B performing the method of FIG. 5A. In FIG. 5C, the responding device A modifies page scanning procedures for receiving paging signals in a generic in-band communication connection from requesting device B, according to an embodiment of the present invention.

FIG. 5D is an example flow diagram 380 of operational steps of an example embodiment of the method carried out by a modular embodiment of responding device A of FIGS. 1A, 1B, and 1C in interacting with the requesting device B performing the method of FIG. 5A. In FIG. 5D, the responding device A modifies page scanning procedures for receiving paging signals in a generic in-band communication connection from requesting device B, according to an embodiment of the present invention.

FIG. 6 is an example timing diagram during the page state of requesting device B, after a conventional Bluetooth™ inquiry procedure, showing a diagram of transmitted pages by requesting device B in the role of a potential master device in a potential piconet, the diagram of pages shown superimposed on a diagram of the page scan intervals of the receiver in responding device A in the role of a potential slave in the potential piconet, according to an embodiment of the present invention.

FIG. 7 is an example timing diagram during the page state of requesting device B, due to the exchange of the NFC handover request record and NFC handover select record of FIGS. 2A and 2B, showing a diagram of transmitted pages by requesting device B in the role of a potential master device in a potential piconet, the diagram of pages shown superimposed on a diagram of the page scan intervals of the receiver in responding device A in the role of a potential slave in the potential piconet, wherein the responding device A modifies the Bluetooth™ page scanning procedures for receiving paging signals, by increasing the duration of the scan window in response to the exchange of the NFC handover request record and NFC handover select record, according to an embodiment of the present invention.

FIG. 8 is an example timing diagram during the page state of requesting device B, due to the exchange of the NFC handover request record and NFC handover select record of FIGS. 2A and 2B, showing a diagram of transmitted pages by requesting device B in the role of a potential master device in a potential piconet, the diagram of pages shown superimposed on a diagram of the page scan intervals of the receiver in responding device A in the role of a potential slave in the potential piconet, wherein the responding device A modifies the Bluetooth™ page scanning procedures for receiving paging signals, by decreasing a duration of a page scanning interval in response to exchange of the NFC handover request record and NFC handover select record, according to an embodiment of the present invention.

### DISCUSSION OF EXAMPLE EMBODIMENTS OF THE INVENTION

Near-field Communication (NFC) Technology

Near-field communication (NFC) technology, for example, may be used as an out-of-band device association technique for a wireless short-range communication connection, such as Bluetooth™ connection described in the Bluetooth™ Specification, Version 4, Jun. 30, 2010. NFC technology enables communication between two NFC Devices or between an NFC Device and an NFC Tag via magnetic field induction. Two loop antennas are located within each other's near field, effectively energizing a wireless contact by forming an air-core transformer. An example NFC radio operates within the unlicensed radio frequency ISM band of 13.56 MHz, with a bandwidth of approximately 2 MHz over a typical distance of a few centimeters. The NFC radio may be affixed to a Bluetooth™ enabled wireless client device (STA) and the user brings the NFC radio on the device close to another Bluetooth™ device to allow near field communication between the devices. NFC technology is an extension of the ISO/IEC 14443 proximity-card standard (incorporated herein by reference) for contactless smartcards and radio frequency ID (RFID) devices, which combines the interface of a contactless smartcard and a reader into a single device, and uses the ISO/IEC 18092 NFC communication standard (incorporated herein by reference) to enable two-way communication. An NFC radio may communicate with both existing ISO/IEC 14443 contactless smartcards and readers, as well as with other NFC devices by using ISO/IEC 18092. The NFC Forum™, a non-profit industry association, has released specifications that enable different operation modes called: tag emulation, read/write mode, and peer to peer communication. Furthermore, NFC Forum has defined specifications for NFC Data Exchange Format (NDEF), NFC Tag Types, NFC Record Type Definition, and Connection Handover Specification. See, for example, Connection Handover Technical Specification, NFC Forum™, Connection Handover 1.2, NFCForum-TS-ConnectionHandover_{—}1_{—}2, 2010-07-07 (incorporated herein by reference). The ISO/IEC 18092 standard defines communication modes for Near Field Communication Interface and Protocol (NFCIP-1) using inductively coupled devices operating at the center frequency of 13,56 MHz for interconnection of computer peripherals. The ISO/IEC 18092 standard specifies modulation schemes, codings, transfer speeds and frame format of the RF interface, initialization schemes, conditions required for data collision control during initialization, and a transport protocol including protocol activation and data exchange methods.

The NFC Data Exchange Format (NDEF) specification, NFC Forum Data Exchange Format (NDEF) Specification, NFC Forum™, 2006 (incorporated herein by reference), defines a common data format for NFC devices to exchange application or service specific data. An NDEF message is constructed of a number of NDEF records, with the first and the last record providing message begin and end markers. Between two NFC Devices, NDEF messages may be exchanged over the NFC Logical Link Control Protocol (LLCP) protocol, specified in NFC Forum Logical Link Control Protocol Specification, NFC Forum™, 2009 (incorporated herein by reference). The NFC Connection Handover specification, NFC Forum Connection Handover Specification, NFC Forum™, 2010 (incorporated herein by reference), defines the exchange of NDEF messages between two NFC Devices in a negotiated handover to discover and negotiate alternative wireless communication technologies.

The NFC Forum™ is preparing an unpublished technical specification, NFC Controller Interface (NCI) Technical Specification, NCI [1.0 Draft 4], NFCForum_TS_NCI_{—}1.0.Draft 4, 2010-06-10 (incorporated herein by reference), which describes NCI data message formats and read/write operations over the NFC controller interface between the host processor and the NFC controller, and payload data extraction from and insertion into NFC radio frequency (RF) signals exchanged between NFC controllers or NFC tags.

Connection Formation Between Bluetooth™ Devices

The procedure for forming connections between Bluetooth™ devices is described in the Bluetooth™ Specification, Version 4, Jun. 30, 2010. The Bluetooth™ Baseband is the part of the Bluetooth™ system that implements the Media Access Control (MAC) and physical layer procedures to support the connection formation, exchange of data information streams, and ad hoc networking between Bluetooth™ devices. Connection formation includes inquiry, inquiry scanning, paging, and page scanning procedures. Inquiry is a procedure where a Bluetooth™ device transmits inquiry messages and listens for responses in order to discover the other Bluetooth™ devices that are within the coverage area. Inquiry scan is a procedure where a Bluetooth™ device listens for inquiry messages received on its inquiry scan physical channel. Page is the initial phase of the connection procedure where a device transmits a train of page messages until a response is received from the target device or a timeout occurs. Page scan is a procedure where a device listens for page messages received on its page scan physical channel.

In forming a connection, the paging device will become the master and the page scan device will become the slave in a piconet. Initially, after the slave has received an inquiry message, an inquiry response packet is transmitted from the slave to the master. The inquiry response packet sent from the slave contains information necessary for the inquiring master to page the slave, such as Bluetooth™ device address and the clock of the slave device.

In the paging procedure, one the Bluetooth™ device that will become the master carries out a page procedure by transmitting page messages in connection request packets to the specified Bluetooth™ slave device that carries out a page scanning procedure to listen for connection request packets from the paging device. A connectable Bluetooth™ device listens for a page request on its page scan channel and, once received, enters into a sequence of exchanges with the paging device. In order for a device to connect to another device, it performs frequency hopping all page scan channel frequencies, sending a page request on each frequency and listening for a response. The page scan channel uses an access code derived from the scanning device's Bluetooth™ device address BD_ADDR to identify communications on the channel. The page scan channel uses a slower hopping rate than the hop rate of the paging device, using the Bluetooth™ device clock of the scanning device as an input. A device listening on its page scan channel remains passive until it receives a page request from another Bluetooth™ device, identified by the page scan channel access code. The two devices will then follow the page procedure to form a connection where the paging device is the master and the page scan device is the slave in a piconet.

In order for a paging device to connect to another Bluetooth™ device, it uses the page scan channel of the target device in order to send page requests. If the paging device does not know the phase of the target device's page scan channel, it does not know the current hop frequency of the target device. Therefore, the paging device transmits page requests on each of the page scan hop frequencies and listens for a page response. This is done at a faster hop rate, allowing the paging device to cover all page scan frequencies in a short period of time. The paging device may have some knowledge of the target device's Bluetooth™ clock, such as indicated during a previous inquiry transaction between the two devices, and may be able to predict the phase of the target device's page scan channel. It may use this information to optimize the synchronization of the paging and page scanning process and speed up the formation of the connection.

Example Embodiment Using NFC Forum Connection Handover Protocol

Method, apparatus, and computer program product embodiments are disclosed to enable out-of-band short-range communication carrier transport switching for connection setup in Bluetooth™ device-to-device communication. The NFC Forum connection handover protocol is used as the Bluetooth™ connection handover procedure to exchange in-band Bluetooth™ communication connection parameters.

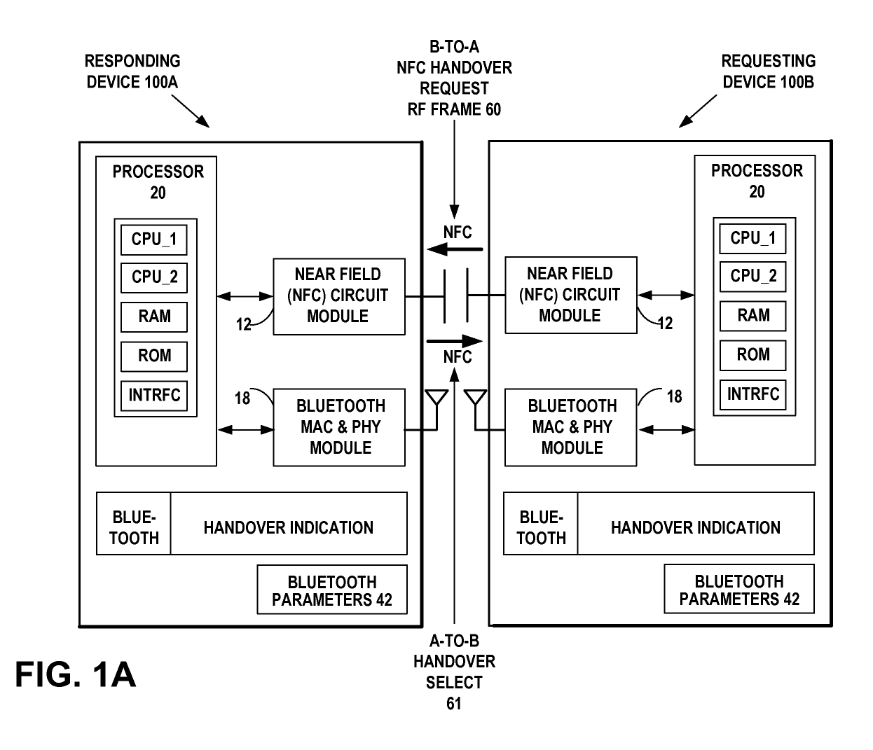

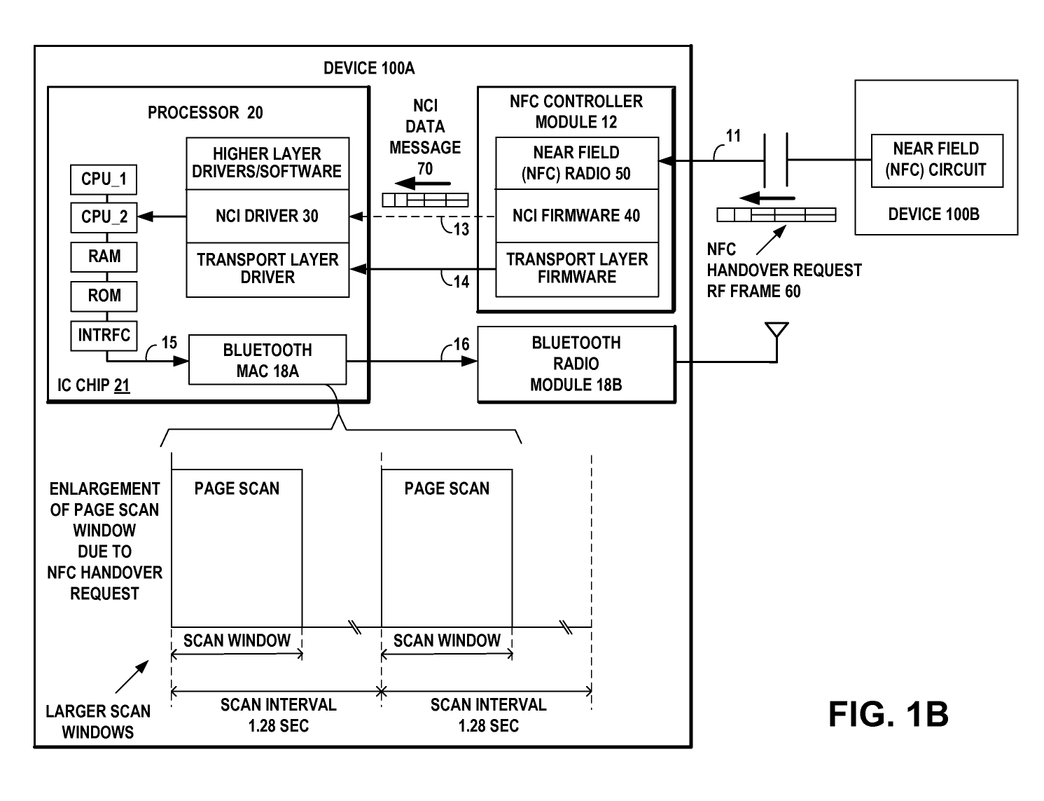

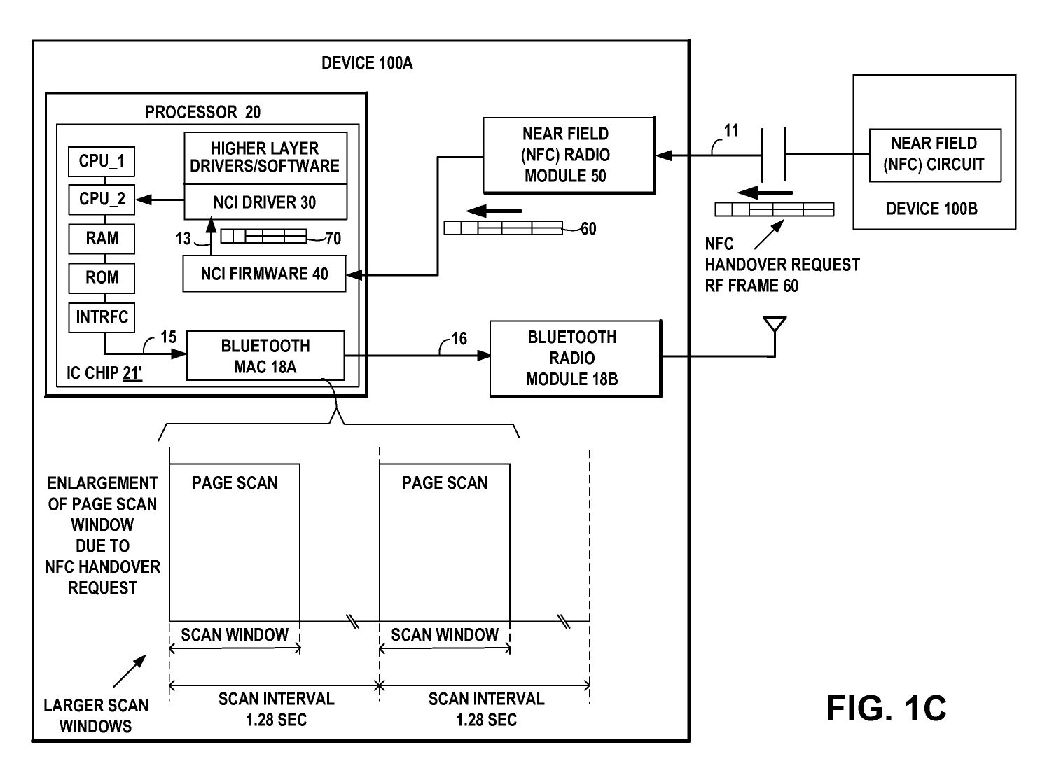

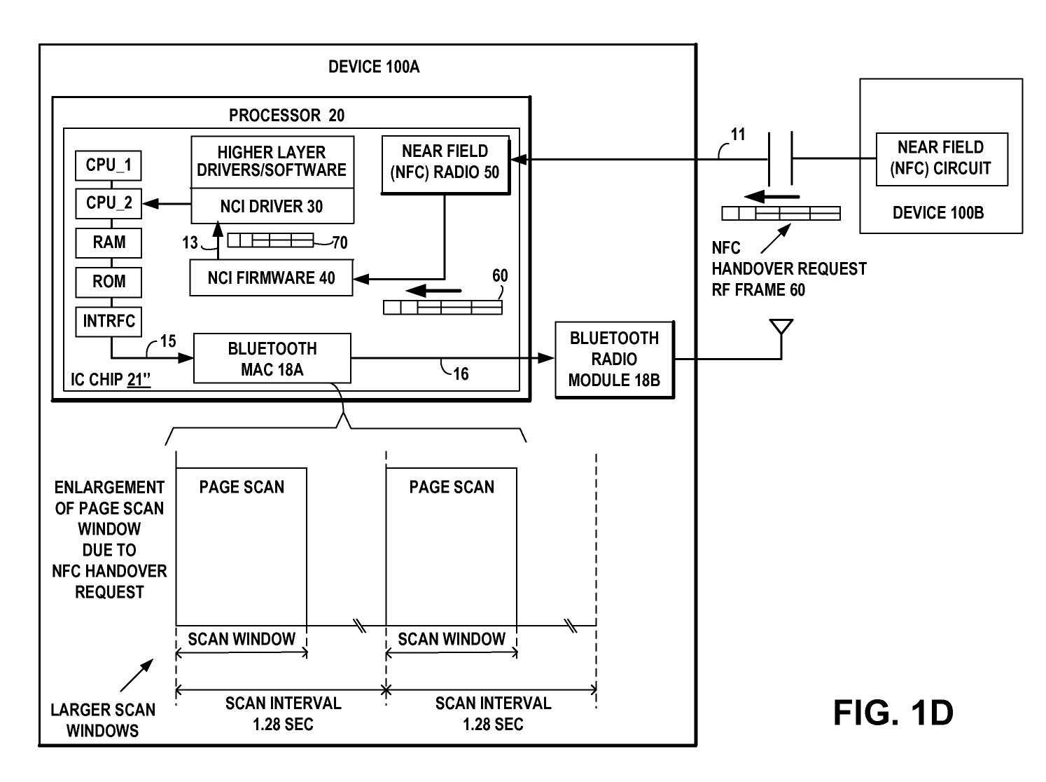

FIG. 1A is an example embodiment of a wireless network diagram of wireless device 100A and wireless device 100B, with device 100B initiating an out-of-band near-field communication connection with device 100A by transmitting wireless communication signals including necessary power for providing the out-of-band near-field communication connection and device 100B further sending in-band Bluetooth™ communication connection parameters including parameters indicating a Bluetooth™ connection handover procedure, to device 100A via the out-of-band near-field communication connection, according to an embodiment of the present invention.

In an example embodiment, wireless device 100A and wireless device 100B are each include an out-of-band short-range carrier transceiver module 12. The out-of-band short-range carrier may be a suitable short-range communications protocol, such as Radio Frequency Identification (RFID), Near Field Communication (NFC), Infrared Data Association (IrDA), or Ultra Wide Band (UWB), for example.

An example of the Radio Frequency Identification (RFID) out-of-band short-range carrier is described, for example, ISO 11785 (air interface protocol), ISO 14443 (air interface protocol), and ISO 15693, incorporated herein by reference.

An example of the Near Field Communication (NFC) out-of-band short-range carrier is described, for example, in ISO/IEC 14443 and ISO/IEC 18092, incorporated herein by reference.

An example of the Infrared Data Association (IrDA) out-of-band short-range carrier is described, for example, in IrDA Link Access Protocol, v1.1 (1996), incorporated herein by reference.

An example of the Ultra Wide Band (UWB) out-of-band short-range carrier is described, for example, in WiMedia Common Radio Platform Specification, Version 1.5 (2010), incorporated herein by reference.

The wireless device 100A and wireless device 100B are each equipped with one or more in-band short-range carrier transceivers, for example the in-band short range transceiver module 18. The in-band short-range carriers may be the Bluetooth™ short-range communications protocol. An example of the Bluetooth™ in-band short-range carrier is described, for example, in Bluetooth™ Core Specification, (Jun. 30, 2010).

Device 100 B is shown in FIG. 1A initiating an out-of-band short-range carrier transport switch with device 100A by transmitting wireless communication signals for providing the out-of-band carrier communication connection, such as Near Field Communication (NFC) signals.

Device 100B is shown in FIG. 1A, then sending in-band short-range carrier communication connection parameters in a transport switch request message 60, including one or more parameters indicating a Bluetooth™ connection handover procedure, to device 100A via the Near Field Communication (NFC) out-of-band short-range carrier communication connection.

In an example embodiment, the wireless device 100A and wireless device 100B of FIG. 1A, may continue with device 100B receiving from device 100A, a NFC communication handover select message 61 including one or more alternate parameters, via the out-of-band NFC communication connection, according to an embodiment of the present invention. Device 100A and device 100B may use the response as a basis to negotiate a mutually agreeable delay interval.

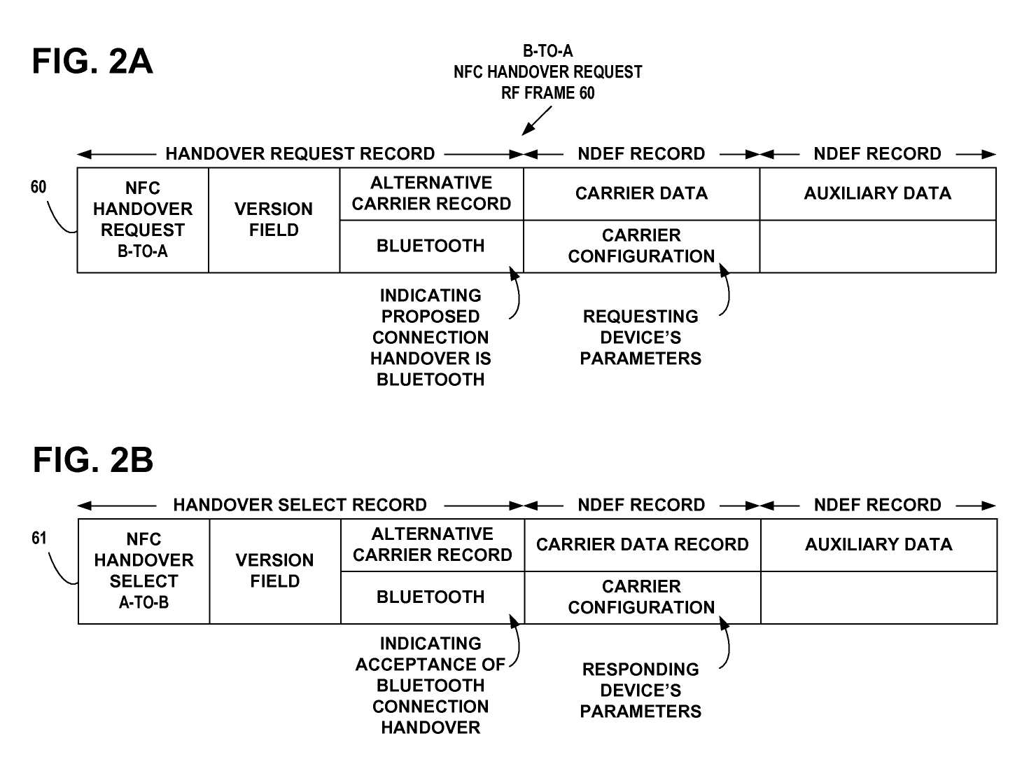

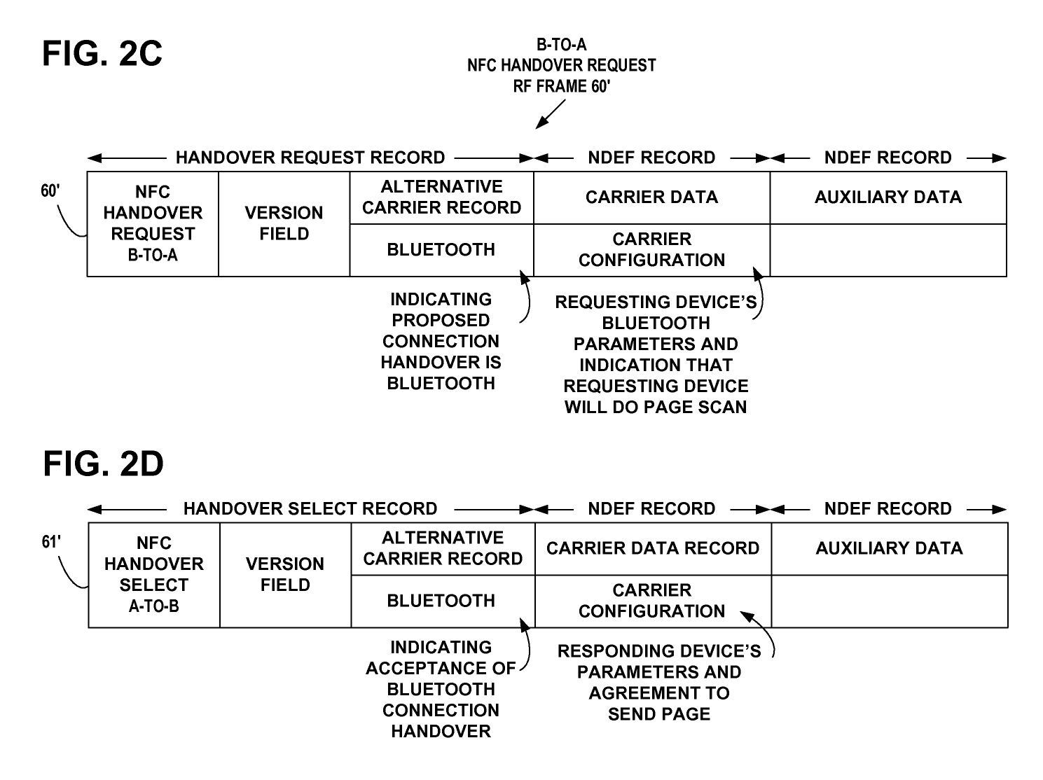

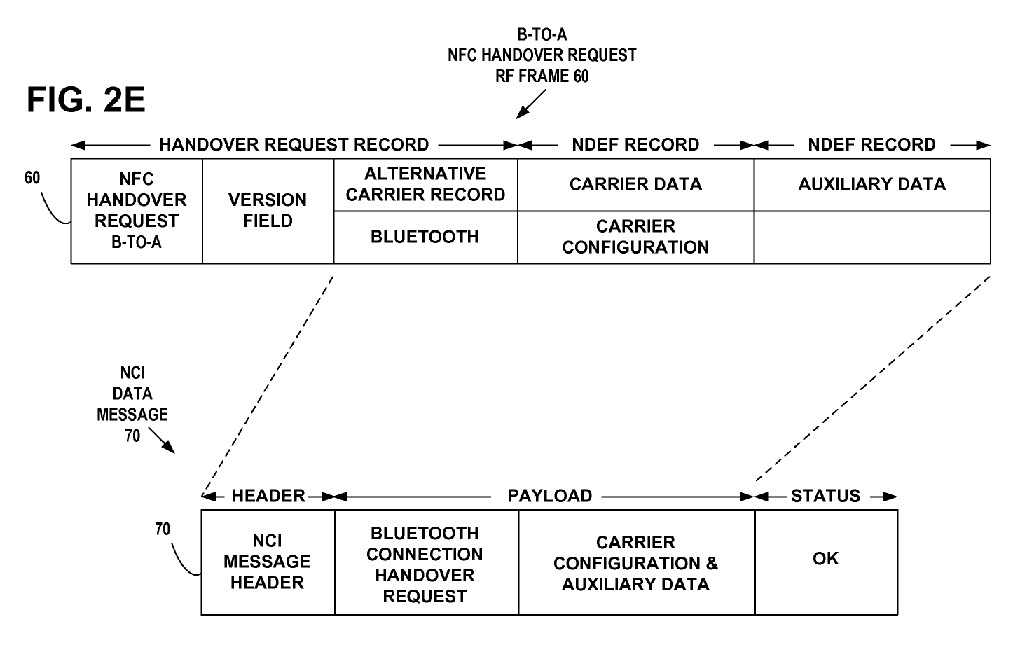

FIG. 2A is an example embodiment NFC handover request record 60 message format from device 100B to device 100A of FIG. 1A, with parameters indicating a proposed Connection Handover as Bluetooth™ and the requesting device 100B's parameters, sent by the requesting device 100B over the NFC link, according to an embodiment of the present invention.

FIG. 2B is an example embodiment NFC handover select record 61 message format from responding device 100A to device 100B of FIG. 1A, with parameters indicating the acceptance by responding device 100A of the proposed Bluetooth™ Connection Handover and the responding device 100A's parameters, sent by the responding device 100A over the NFC link, according to an embodiment of the present invention.

FIG. 2C is an example embodiment NFC handover request record 60′ message format from device 100B to device 100A of FIG. 1A, with parameters indicating a proposed Connection Handover as Bluetooth™ and an indication that the requesting device 100B will do the page scan, sent by the requesting device 100B over the NFC link, according to an embodiment of the present invention. Device 100B may include its Bluetooth™ address BD_ADDR as a parameter to enable device 100A to send pages to device B with an appropriate access code directed to device B.

FIG. 2D is an example embodiment NFC handover select record 61′ message format from responding device 100A to device 100B of FIG. 1A, with parameters indicating the acceptance by responding device 100A of the proposed Bluetooth™ Connection Handover and agreement to send the Bluetooth™ page, sent by the responding device 100A over the NFC link, according to an embodiment of the present invention.

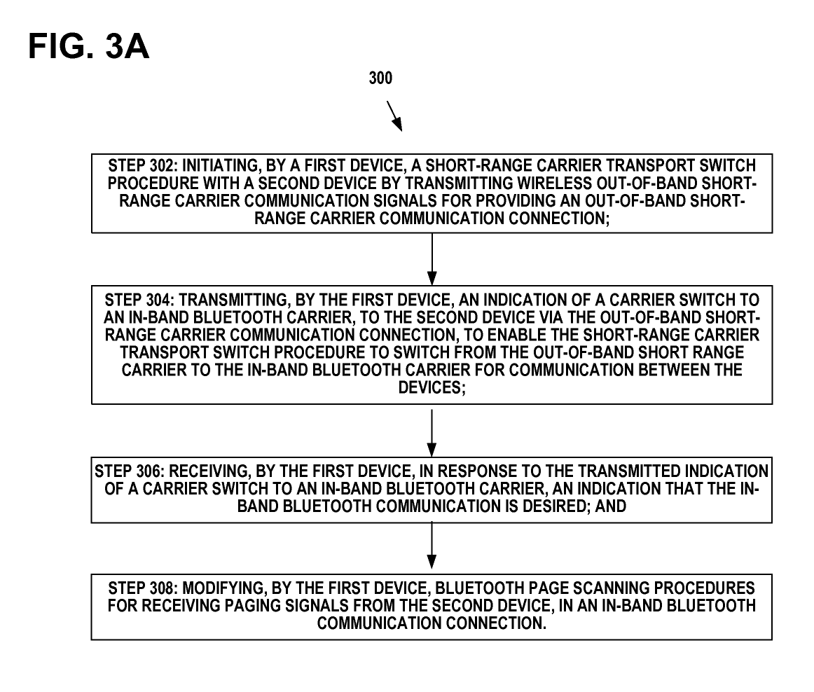

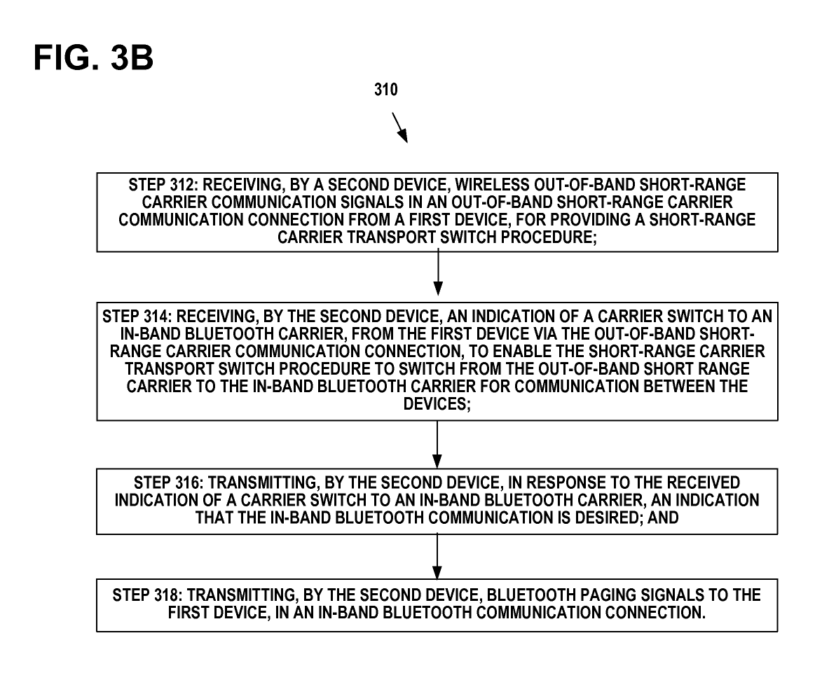

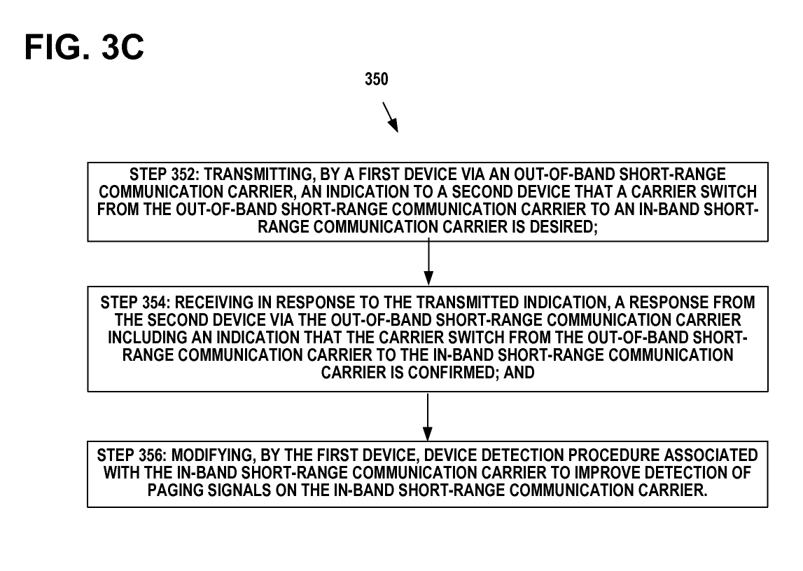

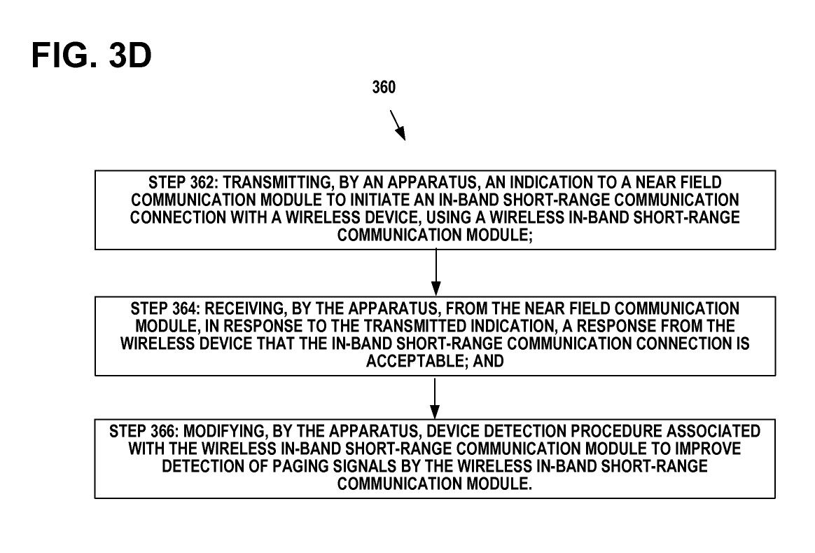

FIG. 3A is an example flow diagram 300 of operational steps of an example embodiment of the method carried out by requesting device B of FIG. 1A, where requesting device B modifies Bluetooth™ page scanning procedures for receiving paging signals in the in-band Bluetooth™ communication connection from the responding device A, in an in-band Bluetooth™ communication connection.

The steps of the flow diagram may represent computer code instructions stored in the RAM and/or ROM memory of the wireless device 100B, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 302: initiating, by a first device, a short-range carrier transport switch procedure with a second device by transmitting wireless out-of-band short-range carrier communication signals for providing an out-of-band short-range carrier communication connection. The NFC Forum connection handover protocol may be used, for example, as the short-range carrier transport switch procedure for the carrier switch to an in-band Bluetooth™ carrier.

Step 304: transmitting, by the first device, an indication of a carrier switch to an in-band Bluetooth™ carrier, to the second device via the out-of-band short-range carrier communication connection, to enable the short-range carrier transport switch procedure to switch from the out-of-band short range carrier to the in-band Bluetooth™ carrier for communication between the devices. This may be accomplished, for example, by sending the NFC handover request record 60 from the requesting device 100B to the responding device 100A, shown in FIG. 2A or FIG. 2C.

Step 306: receiving, by the first device, in response to the transmitted indication of a carrier switch to an in-band Bluetooth™ carrier, an indication that the in-band Bluetooth™ communication is desired. This may be accomplished, for example, by receiving by the requesting device 100B, the NFC handover select record 61 from responding device 100A, of FIG. 2B or FIG. 2D.

Step 308: modifying, by the first device, Bluetooth™ page scanning procedures for receiving paging signals from the second device, in an in-band Bluetooth™ communication connection. The page scanning procedures may be modified, for example, by increasing a duration of a page scanning window or by decreasing a duration of a page scanning interval.

The resulting embodiments enable forming a Bluetooth™ ad hoc network as an in-band short-range carrier, by using near-field communication (NFC) signals in an out-of-band device-to-device connection setup.

FIG. 3B is an example flow diagram 310 of operational steps of an example embodiment of the method carried out by responding device A of FIG. 1A in interacting with the requesting device B performing the method of FIG. 3A. In FIG. 3B, the responding device A sends Bluetooth™ paging signals in the in-band Bluetooth™ communication connection to the requesting device B, according to an embodiment of the present invention.

The steps of the flow diagram may represent computer code instructions stored in the RAM and/or ROM memory of the wireless device 100B, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 312: receiving, by a second device, wireless out-of-band short-range carrier communication signals in an out-of-band short-range carrier communication connection from a first device, for providing a short-range carrier transport switch procedure. The NFC Forum connection handover protocol may be used, for example, as the short-range carrier transport switch procedure for the carrier switch to an in-band Bluetooth™ carrier.

Step 314: receiving, by the second device, an indication of a carrier switch to an in-band Bluetooth™ carrier, from the first device via the out-of-band short-range carrier communication connection, to enable the short-range carrier transport switch procedure to switch from the out-of-band short range carrier to the in-band Bluetooth™ carrier for communication between the devices. This may be accomplished, for example, by receiving the NFC handover request record 60 by the responding device 100A from the requesting device 100B, shown in FIG. 2A or FIG. 2C.

Step 316: transmitting, by the second device, in response to the received indication of a carrier switch to an in-band Bluetooth™ carrier, an indication that the in-band Bluetooth™ communication is desired. This may be accomplished, for example, by sending the NFC handover select record 61 from responding device 100A to the requesting device 100B, of FIG. 2B or FIG. 2D.

Step 318: transmitting, by the second device, Bluetooth™ paging signals to the first device, in an in-band Bluetooth™ communication connection.

FIG. 3C is an example flow diagram 350 of operational steps of an example embodiment of the method carried out by requesting device 100B of FIG. 1A, 1B, 1C, or 1D, where requesting device 100B modifies page scanning procedures for receiving paging signals in a generic in-band communication connection from the responding device A, in a generic in-band communication connection.

The steps of the flow diagram may represent computer code instructions stored in the RAM and/or ROM memory of the wireless device 100B, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 352: transmitting, by a first device via an out-of-band short-range communication carrier, an indication to a second device that a carrier switch from the out-of-band short-range communication carrier to an in-band short-range communication carrier is desired;

Step 354: receiving in response to the transmitted indication, a response from the second device via the out-of-band short-range communication carrier including an indication that the carrier switch from the out-of-band short-range communication carrier to the in-band short-range communication carrier is confirmed; and

Step 356: modifying, by the first device, device detection procedure associated with the in-band short-range communication carrier to improve detection of paging signals on the in-band short-range communication carrier.

FIG. 3D is an example flow diagram 360 of operational steps of an example embodiment of the method carried out by modular components of the requesting device 100B of FIG. 1A, 1B, or 1C, where requesting device 100B modifies page scanning procedures for receiving paging signals in a generic in-band communication connection from the responding device A, in a generic in-band communication connection.

The steps of the flow diagram may represent computer code instructions stored in the RAM and/or ROM memory of the wireless device 100B, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 362: transmitting, by an apparatus, an indication to a near field communication module to initiate an in-band short-range communication connection with a wireless device, using a wireless in-band short-range communication module;

Step 364: receiving, by the apparatus, from the near field communication module, in response to the transmitted indication, a response from the wireless device that the in-band short-range communication connection is acceptable; and

Step 366: modifying, by the apparatus, device detection procedure associated with the wireless in-band short-range communication module to improve detection of paging signals by the wireless in-band short-range communication module.

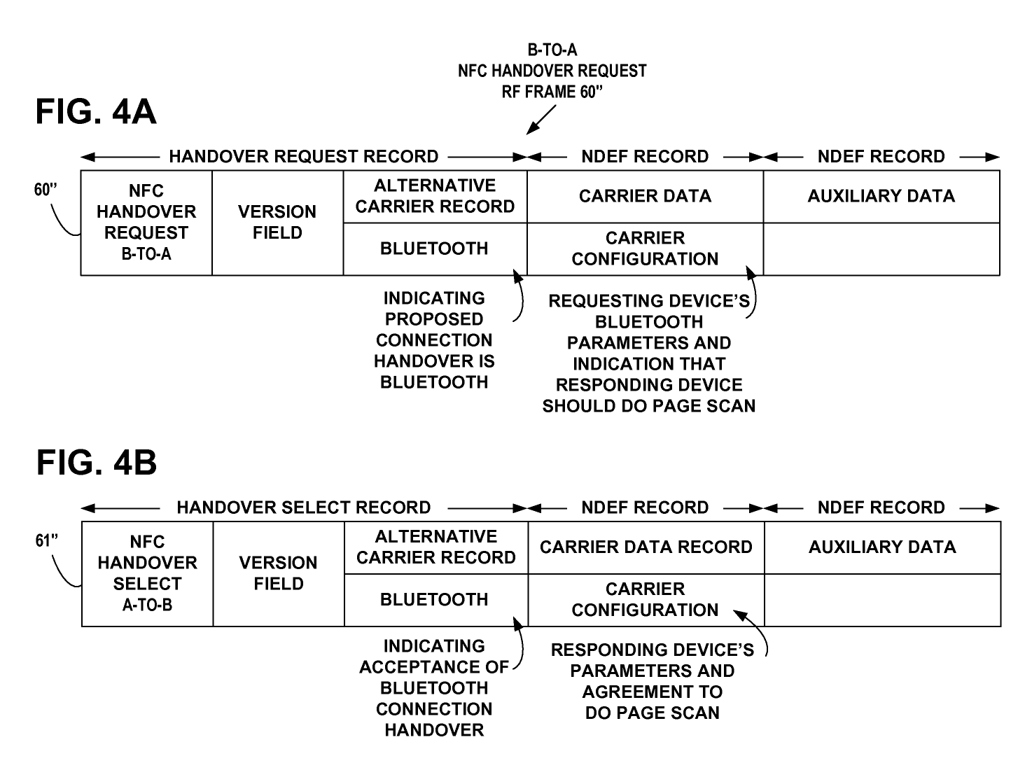

FIG. 4A is an example embodiment NFC handover request record message format 60″ from device B to device A of FIG. 1A, with parameters indicating a proposed Connection Handover as Bluetooth™ and an indication that the responding device A should do the page scan, sent by the requesting device B over the NFC link, according to an embodiment of the present invention.

FIG. 4B is an example embodiment NFC handover select record message format 61″ from responding device A to device B of FIG. 1A, with parameters indicating the acceptance by responding device A of the proposed Bluetooth™ Connection Handover and agreement to do the page scan, sent by the responding device A over the NFC link, according to an embodiment of the present invention. Device 100A may include its Bluetooth™ address BD_ADDR as a parameter to enable device 100B to send pages to device A with an appropriate access code directed to device A.

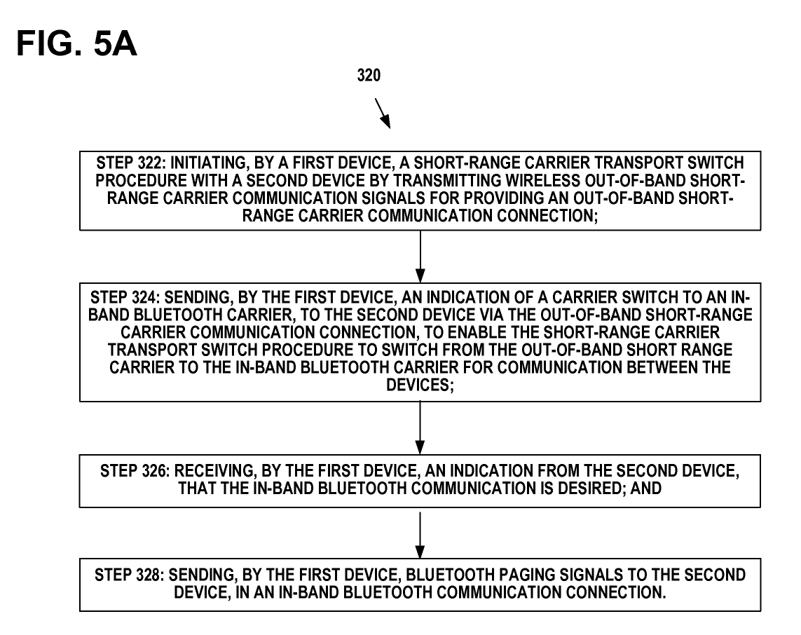

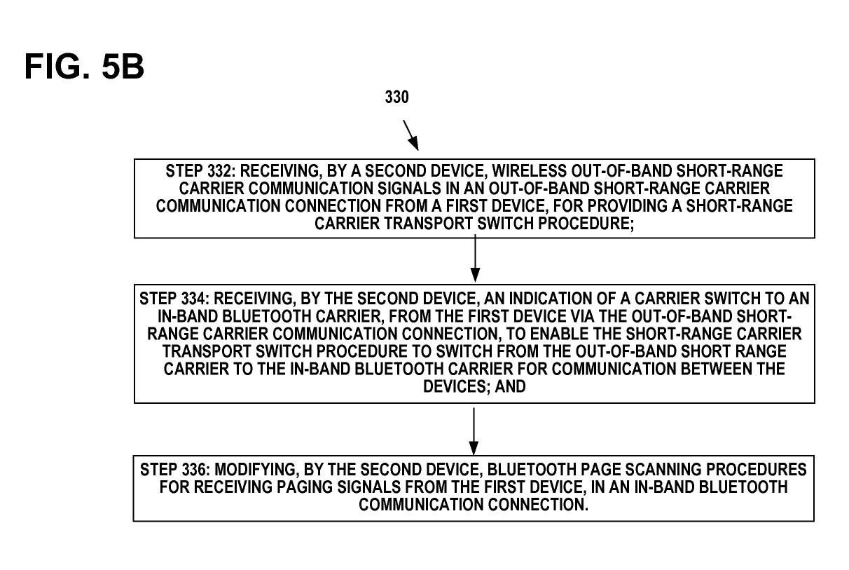

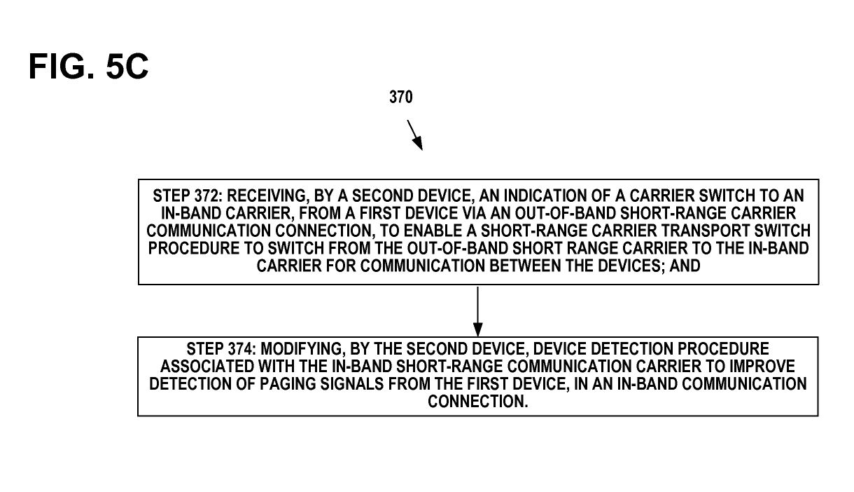

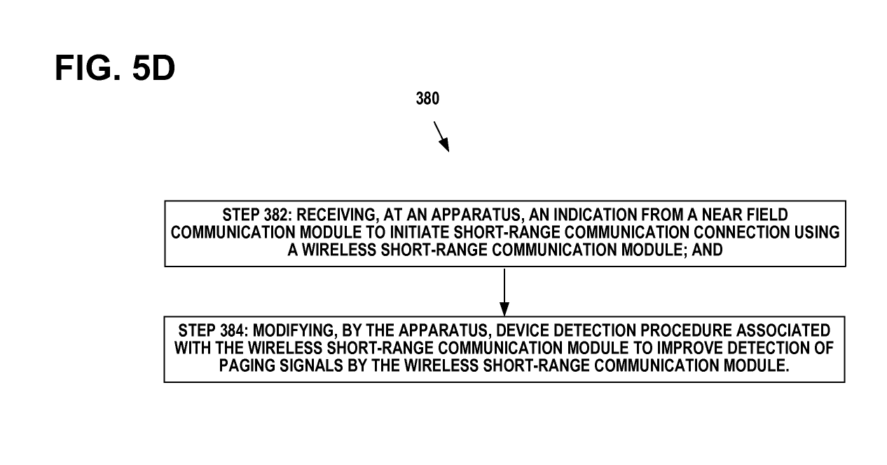

FIG. 5A is an example flow diagram 320 of operational steps of an example embodiment of the method carried out by requesting device B of FIG. 1A, where requesting device B sends Bluetooth™ paging signals in the in-band Bluetooth™ communication connection to the responding device A, according to an embodiment of the present invention.

The steps of the flow diagram may represent computer code instructions stored in the RAM and/or ROM memory of the wireless device 100B, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 322: initiating, by a first device, a short-range carrier transport switch procedure with a second device by transmitting wireless out-of-band short-range carrier communication signals for providing an out-of-band short-range carrier communication connection. The NFC Forum connection handover protocol may be used, for example, as the short-range carrier transport switch procedure for the carrier switch to an in-band Bluetooth™ carrier.

Step 324: sending, by the first device, an indication of a carrier switch to an in-band Bluetooth™ carrier, to the second device via the out-of-band short-range carrier communication connection, to enable the short-range carrier transport switch procedure to switch from the out-of-band short range carrier to the in-band Bluetooth™ carrier for communication between the devices. This may be accomplished, for example, by sending the NFC handover request record 60″ from the requesting device 100B to the responding device 100A, shown in FIG. 4A.

Step 326: receiving, by the first device, an indication from the second device, that the in-band Bluetooth™ communication is desired. This may be accomplished, for example, by receiving by the requesting device 100B, the NFC handover select record 61″ from responding device 100A, of FIG. 4B.

Step 328: sending, by the first device, Bluetooth™ paging signals to the second device, in an in-band Bluetooth™ communication connection.

FIG. 5B is an example flow diagram 330 of operational steps of an example embodiment of the method carried out by responding device A of FIG. 1A in interacting with the requesting device B performing the method of FIG. 5A. In FIG. 5B, the responding device A modifies Bluetooth™ page scanning procedures for receiving paging signals in the in-band Bluetooth™ communication connection from requesting device B, according to an embodiment of the present invention.

The steps of the flow diagram may represent computer code instructions stored in the RAM and/or ROM memory of the wireless device 100B, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 332: receiving, by a second device, wireless out-of-band short-range carrier communication signals in an out-of-band short-range carrier communication connection from a first device, for providing a short-range carrier transport switch procedure. The NFC Forum connection handover protocol may be used, for example, as the short-range carrier transport switch procedure for the carrier switch to an in-band Bluetooth™ carrier.

Step 334: receiving, by the second device, an indication of a carrier switch to an in-band Bluetooth™ carrier, from the first device via the out-of-band short-range carrier communication connection, to enable the short-range carrier transport switch procedure to switch from the out-of-band short range carrier to the in-band Bluetooth™ carrier for communication between the devices. This may be accomplished, for example, by receiving the NFC handover request record 60″ by the responding device 100A from the requesting device 100B, shown in FIG. 4A.

Step 336: modifying, by the second device, Bluetooth™ page scanning procedures for receiving paging signals from the first device, in an in-band Bluetooth™ communication connection. The page scanning procedures may be modified, for example, by increasing a duration of a page scanning window and/or by decreasing a duration of a page scanning interval.

FIG. 5C is an example flow diagram 370 of operational steps of an example embodiment of the method carried out by responding device 100A of FIGS. 1A, 1B, 1C, and 1D in interacting with the requesting device B performing the method of FIG. 5A. In FIG. 5C, the responding device 100A modifies page scanning procedures for receiving paging signals in a generic in-band communication connection from requesting device B, according to an embodiment of the present invention.

The steps of the flow diagram may represent computer code instructions stored in the RAM and/or ROM memory of the responding device 100A, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 372: receiving, by a second device, an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and

Step 374: modifying, by the second device, device detection procedure associated with the in-band short-range communication carrier to improve detection of paging signals from the first device, in an in-band communication connection.

FIG. 5D is an example flow diagram 380 of operational steps of an example embodiment of the method carried out by a modular embodiment of responding device 100A of FIGS. 1A, 1B, and 1C in interacting with the requesting device B performing the method of FIG. 5A. In FIG. 5D, the responding device 100A modifies page scanning procedures for receiving paging signals in a generic in-band communication connection from requesting device B, according to an embodiment of the present invention.

The steps of the flow diagram may represent computer code instructions stored in the RAM and/or ROM memory of the responding device 100A, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 382: receiving, at an apparatus, an indication from a near field communication module to initiate short-range communication connection using a wireless short-range communication module; and

Step 384: modifying, by the apparatus, device detection procedure associated with the wireless short-range communication module to improve detection of paging signals by the wireless short-range communication module.

The steps of the example method may further comprise determining by the apparatus, that the in-band short-range communication connection is acceptable before modifying the device detection procedure associated with the wireless short-range communication module.

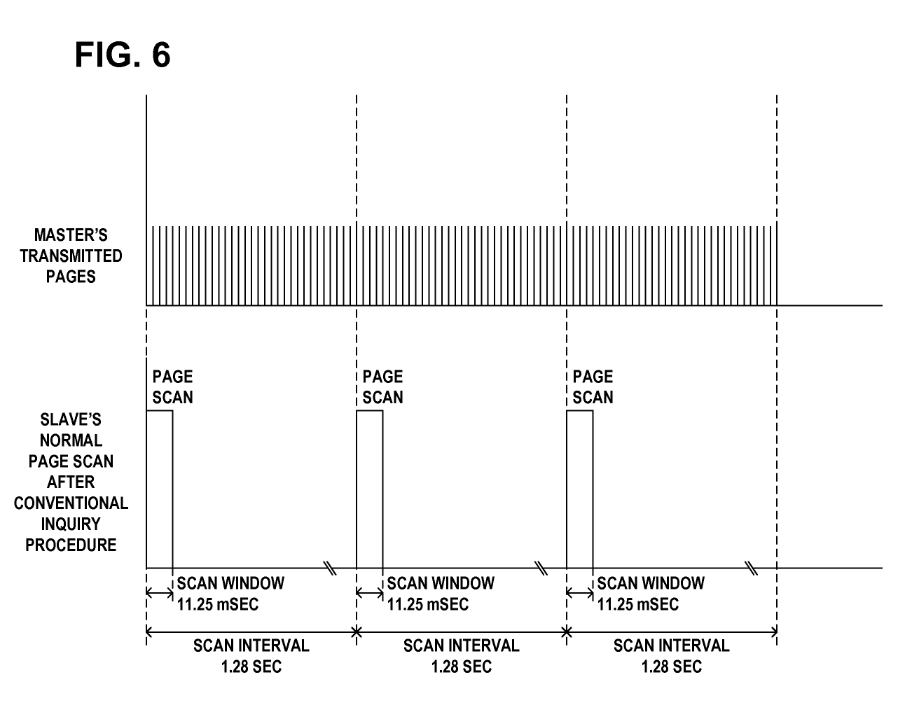

FIG. 6 is an example timing diagram during the page state of requesting device B, after a conventional Bluetooth™ inquiry procedure, as described in described the Bluetooth™ Specification, Version 4, Jun. 30, 2010. FIG. 6 shows a diagram of transmitted pages by requesting device B in the role of a potential master device in a potential piconet, the diagram of pages shown superimposed on a diagram of the page scan intervals of the receiver in responding device A in the role of a potential slave in the potential piconet, according to an embodiment of the present invention. The default page scan intervals are 1.28 seconds and the default scan window is 11.25 milliseconds.

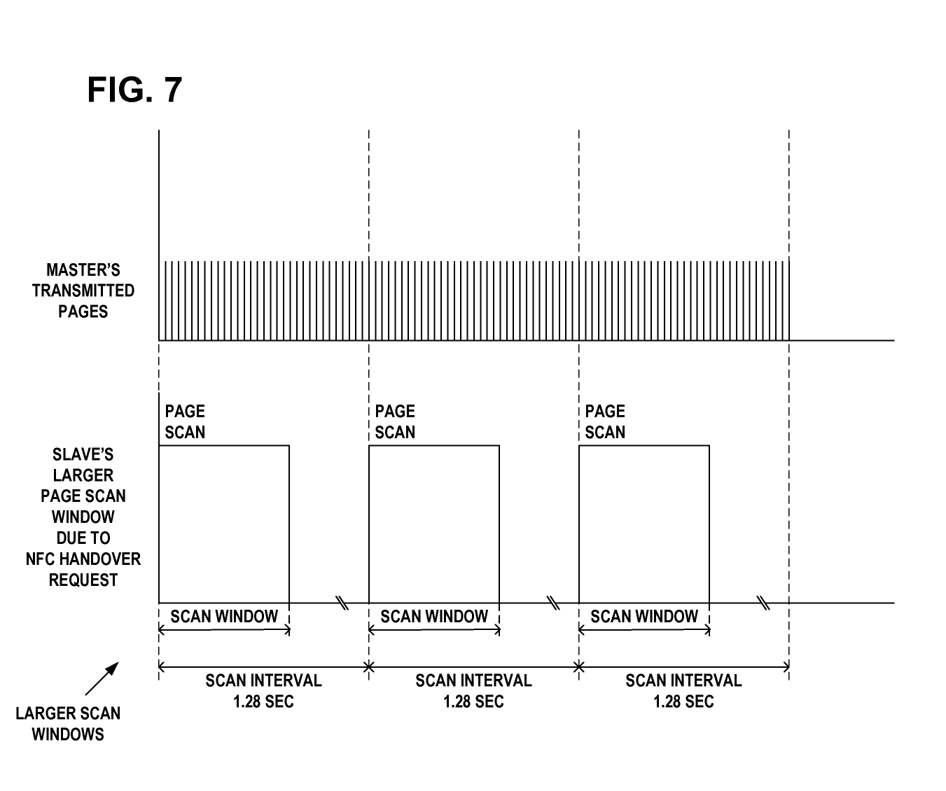

FIG. 7 is an example timing diagram during the page state of requesting device B, due to the exchange of the NFC handover request record and NFC handover select record of FIGS. 2A and 2B, showing a diagram of transmitted pages by requesting device B in the role of a potential master device in a potential piconet, the diagram of pages shown superimposed on a diagram of the page scan intervals of the receiver in responding device A in the role of a potential slave in the potential piconet, wherein the responding device A modifies the Bluetooth™ page scanning procedures for receiving paging signals, by increasing the duration of the scan window to be larger than the default value of 11.25 milliseconds in response to the exchange of the NFC handover request record and NFC handover select record. In embodiments of the invention, the scan window may be enlarged so as to be continuous. Using the NFC Forum connection handover protocol as the Bluetooth™ connection handover procedure enables accelerating the Bluetooth™ paging procedure. The responding device may modify its page scanning procedure as soon as the device has enough information after the handover request is received.

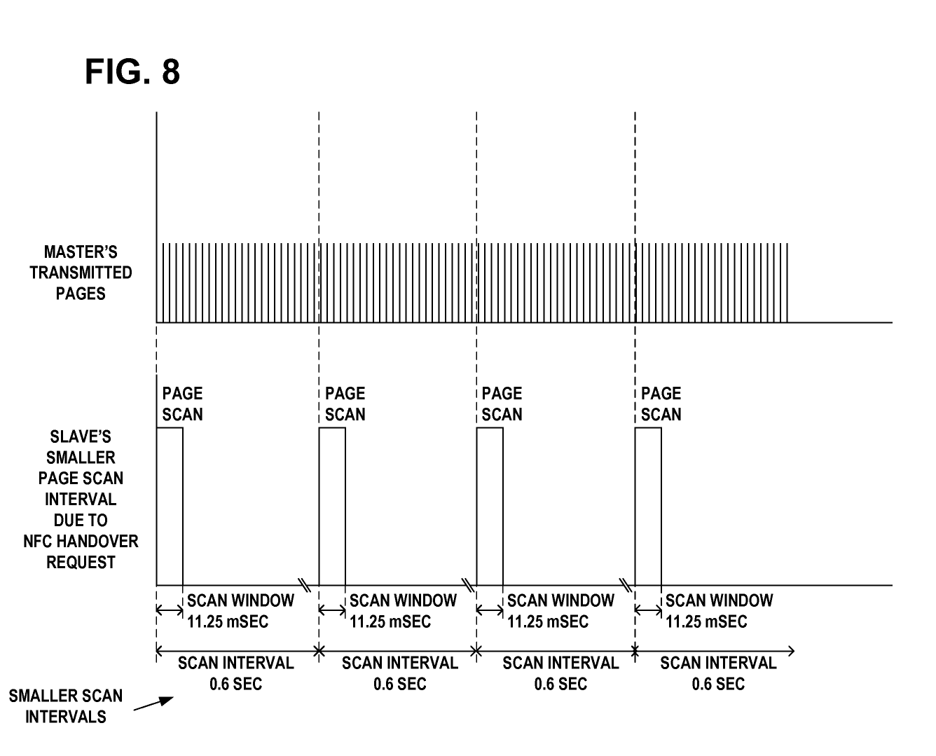

FIG. 8 is an example timing diagram during the page state of requesting device B, due to the exchange of the NFC handover request record and NFC handover select record of FIGS. 2A and 2B, showing a diagram of transmitted pages by requesting device B in the role of a potential master device in a potential piconet, the diagram of pages shown superimposed on a diagram of the page scan intervals of the receiver in responding device A in the role of a potential slave in the potential piconet, wherein the responding device A modifies the Bluetooth™ page scanning procedures for receiving paging signals, by decreasing a duration of a page scanning interval to be less than the default value of 1.28 seconds in response to exchange of the NFC handover request record and NFC handover select record. Using the NFC Forum connection handover protocol as the Bluetooth™ connection handover procedure enables accelerating the Bluetooth™ paging procedure. The responding device may modify its page scanning procedure as soon as the device has enough information after the handover request is received.

In an example embodiment, the wireless device 100B may be a communications device, PDA, cell phone, laptop or palmtop computer, or the like. The wireless device 100B of FIG. 1A includes a processor 20, which includes a dual core central processing unit (CPU_{—}1 and CPU_{—}2), a random access memory (RAM), a read only memory (ROM), and interface circuits to interface with one or more radio transceivers 10, battery and other power sources, key pad, touch screen, display, microphone, speakers, ear pieces, camera or other imaging devices, etc. in the devices 100A. The RAM and ROM can be removable memory devices such as smart cards, SIMs, WIMs, semiconductor memories such as RAM, ROM, PROMS, flash memory devices, etc. A Bluetooth™ Media Access Control (MAC) and PHY 18 module are provided and Bluetooth™ parameters 42 are included. The wireless device 100A has similar components to those in device 100B.

In the example embodiment, the first device 100B initiates an out-of-band near-field communication connection with the second device 100A by transmitting wireless communication signals including necessary power for providing the near-field communication connection. Then the first device 100B sends a handover request message 60 including in-band short-range communication connection parameters, to the second device 100A via the out-of-band near-field communication connection.

The NFC circuit 12 in device 100B communicates bidirectionally with NFC circuit 12 in device 100A via magnetic field induction, where two loop antennas are located within each other's near field, effectively energizing a wireless contact by forming an air-core transformer. An example NFC radio of NFC circuit 12 operates within the unlicensed radio frequency ISM band of 13.56 MHz, with a bandwidth of approximately 2 MHz over a typical distance of a few centimeters. The NFC circuit 12 may be affixed to a new wireless client device 100B and the user brings the NFC radio on the device close to the NFC circuit 12 of the second device 100A to allow near field, bidirectional communication between the devices. NFC technology is an extension of the ISO/IEC 14443 proximity-card standard for contactless smartcards and radio frequency ID (RFID) devices, which combines the interface of a contactless smartcard and a reader into a single device, and uses the ISO/IEC 18092 NFC communication standard to enable two-way communication. An NFC radio may communicate with both existing ISO/IEC 14443 contactless smartcards and readers, as well as with other NFC devices by using ISO/IEC 18092.

When two NFC Devices 100A and 100B are brought into close proximity, they may establish NFC communication based on the NFC Forum Logical Link Control Protocol (LLCP) specification. If one of the devices 100B has intention to activate a further (wireless) communication method, it may then use the NFC Forum Connection Handover protocol to announce possible communication means, including its suggestion for configuration data, and request the other device 100A to respond with its selection of matching technologies, including its suggestion for configuration data. When an NFC requestor device 100B has established LLCP communication with an NFC selector device 100A, the requestor device 100B sends a handover request message 60 with its suggestion for Bluetooth™ parameters including one or more parameters.

In example embodiments of the invention, the NFC circuit 12 in devices 100A and/or 100B of FIG. 1A may be a contactless smartcard and a reader having characteristics similar to those described in the ISO/IEC 14443 proximity-card standard, the smartcard and reader being associated or combined as a single component capable of two-way communication, and uses the ISO/IEC 18092 NFC communication standard to enable both devices 100A and 100B send parameters to each other, according to an embodiment of the present invention.

The Bluetooth™ parameters 42 may include a device's Bluetooth™ device address BD_ADDR, a Bluetooth™ piconet identifier, authentication and encryption type deployed by the wireless network, a network key that a wireless station needs to authenticate with the network, and an address of a device receiving the configuration, if known.

The Bluetooth™ MAC 18 and Bluetooth™ parameters 42 may be embodied as program logic stored in the RAM and/or ROM in the form of sequences of programmed instructions which, when executed in the CPU, carry out the functions of the disclosed embodiments. The program logic can be delivered to the writeable RAM, PROMS, flash memory devices, etc. of the wireless device 100A from a computer program product or article of manufacture in the form of computer-usable media such as resident memory devices, smart cards or other removable memory devices. Alternately, they can be embodied as integrated circuit logic in the form of programmed logic arrays or custom designed application specific integrated circuits (ASIC). The one or more PHY radios 10 in the wireless device 100A or 100B may be separate transceiver circuits or alternately, the one or more radios 10 may be a single RF module capable of handling one or multiple channels in a high speed, time and frequency multiplexed manner in response to the processor 20. Both device A and device B may have the same or similar components as described for device A.

In an alternate example embodiment of the invention, RFID transponders may be used in devices A and B, which may be the passive type or the active type. A passive RFID transponder requires no internal power source to communicate with an RFID reader, and is only active when it is near an RFID reader that energizes the transponder with a continuous radio frequency signal at a resonant frequency of the antenna. The small electrical current induced in the antenna by the continuous radio frequency signal provides enough power for the integrated circuit in the transponder to power up and transmit a modulated response, typically by backscattering the continuous carrier wave from the RFID reader. A passive RFID transponder may include writable electrically erasable, programmable, read-only memory (EEPROM) for storing data received from the RFID reader, which modulates the continuous carrier wave sent by the RFID reader. Reading distances for passive RFID transponders typically range from a few centimeters to a few meters, depending on the radio frequency and antenna design. By contrast, active RFID transponders require a power source to receive and transmit information with an RFID reader. The RFID transponder may be affixed to a new wireless client device 100A and the user brings the RFID transponder on the device 100A close to the reader a device 100B to allow near field communication between the devices.

The NFC touch or energization takes place when the NFC circuits are placed in close proximity. Device 100B generates parameters and sends them to device 100A in the NFC handover request 60. Device 100A generates parameters and sends them to device 100B in the NFC handover select 61. Then the device 100B performs the Bluetooth™ connection setup with device A using the settings for device A obtained in the handover request from device B, according to an embodiment of the present invention.

NDEF messages enable a handover requester 100B to negotiate with the handover selector 100A over the NFC link.

The handover request message 60 is composed of a handover request record that identifies the version of the handover specification being used, and the alternative carrier record that identifies the target carrier type to which that handover is directed, such as a handover from the NFC link to a Bluetooth™ link. The handover request record may have a plurality of alternative carrier records, one for each of a plurality of possible target carriers. The handover request record is followed by several NDEF records. Each alternative carrier record in the handover request record includes pointers to related NDEF records. The first NDEF record pointed to by an alternative carrier record contains carrier configuration characterizing the intended target carrier, such as Bluetooth™. The following NDEF record pointed to by the alternative carrier record contains auxiliary data associated with the intended target carrier or other information related to the handover to the target carrier.

Example Modular Embodiment Using NFC Controller Interface (NCI)

FIG. 1B is an example embodiment of the wireless device 100A of FIG. 1A, illustrating the processor 20, NFC controller module 12, and Bluetooth™ radio module 18B in the device 100A, shown with a superimposed diagram of the page scan intervals established by the Bluetooth™ Media Access Control (MAC) 18A in the processor 20, the device 100A assuming the role of a potential slave in a potential piconet with device 100B. The processor 20 causes the Bluetooth™ MAC 18A to modify the Bluetooth™ page scanning procedures for the Bluetooth™ radio module 18B receiving paging signals. The page scanning procedures may be modified, for example, by increasing a duration of a page scanning window or by decreasing a duration of a page scanning interval. The page scanning procedures are modified in response to an NFC Controller Interface (NCI) data message 70 received from the NFC controller module 12 indicating that the NFC controller module 12 has received an NFC handover request RF frame 60 from device 100B, according to an embodiment of the present invention.

FIG. 2E shows an example of the extraction by the NFC controller module 12 in device 100A, of the payload data from the NFC handover request RF frame 60 received from device 100B, including parameters indicating a proposed Connection Handover as Bluetooth™, and insertion by the NFC controller module 12 of that payload data into an NCI data message 70 that is forwarded to the processor 20 of device 100A.

The NFC handover request RF frame 60 from device 100B is received by the NFC antenna 11 of the near field (NFC) radio 50 of device 100A and passes to the NCI firmware 40 of the NFC controller module 12 in device 100A. The NCI firmware 40 passes the NFC handover request 60 to the transport layer firmware of device 100A. The NCI firmware 40 extracts the payload data from the NFC handover request 60 and inserts it into the NCI data message 70, as shown in FIG. 2E. The payload data includes parameters indicating a proposed Connection Handover as Bluetooth™. The transport layer firmware sends the NCI data message 70 over the NCI controller interface 13/14 to the transport layer driver in the processor 20, which passes the NCI data message 70 to the NCI driver 30 in the processor 20. The CPU_{—}1 and CPU_{—}2 in processor 20 are programmed to recognize the Connection Handover request in the NCI data message 70 as designating Bluetooth™ as the alternate carrier. In response, the processor 20 passes a control signal over path 15 to the Bluetooth™ MAC 18A to modify the Bluetooth™ page scanning procedures for the Bluetooth™ radio 18B when it searches for paging signals from device 100B.

The NCI driver 30 in device 100A communicates over the NFC controller interface (NCI) 13/14 with the NCI firmware 40 in the NFC controller 12 via the transport layer driver in device 100A and the transport layer firmware in NFC controller module 12. The NFC controller module 12 may be embodied as hardware, software, firmware, or a combination of these constructs. It may be an integral part of the processor 20 in device 100A or it my be an integrated circuit chip or card physically attached to the device 100A, such as with a flash card adapter. The NFC controller module 12 may include the NFC radio 50 or the NFC radio 50 may be separately connected. The NFC controller module 12A may include its own battery or it may use power supplied by the device 100A.

The transport layer driver, NCI driver 30, higher layer driver software, and Bluetooth™ MAC 18A in the processor 20 of device 100A may all be embodied as program code stored in the RAM or ROM memories of the processor 20 of device 100A, which when executed by the central processing units (CPU_{—}1/CPU_{—}2), carry out their respective functions.

NCI firmware 40 in the NFC controller module 12 communicates bidirectionally with an NFC controller in device 100B via magnetic field induction, where two loop antennas 11 are located within each other's near-field, effectively energizing a wireless contact by forming an air-core transformer. The NFC radio 50 operates within the unlicensed radio frequency ISM band of 13.56 MHz, with a bandwidth of approximately 2 MHz over a typical distance of a few centimeters.

FIG. 1B, illustrates the processor 20 as an integrated circuit chip 21 connected to the NFC controller module 12 over the NFC controller interface (NCI) 13/14, according to an embodiment of the present invention.

Device 100B in the example embodiment of FIG. 1B has the same modular components as are shown for device 100A, and includes processor 20, NFC controller module 12, and Bluetooth™ radio module 18B. In alternate embodiments of the invention, device 100B of FIG. 1B may be the requesting device and intends to receive pages from device 100A, wherein requesting device 100B will modify its scan procedures when searching for the pages from device 100A. In these alternate embodiments, processor 20 will transmit via the NFC controller module 12 an NFC handover request RF frame to device 100A, with an indication that a carrier switch from the NFC out-of-band short-range communication carrier to a Bluetooth™ in-band short-range communication carrier is desired. Device 100B processor 20 will receive in response to the transmitted indication, a response from device 100A via the NFC controller module 12 via the NFC out-of-band short-range communication carrier including an indication that the carrier switch from the NFC out-of-band short-range communication carrier to the Bluetooth™ in-band short-range communication carrier is confirmed. Then CPU_{—}1 and CPU_{—}2 in processor 20 passes a control signal over path 15 to the Bluetooth™ MAC 18A to modify the Bluetooth™ page scanning procedures for the Bluetooth™ radio module 18B when it searches for paging signals from device 100A.

FIG. 1C is an example embodiment of the wireless device A of FIG. 1B, illustrating the processor 20 as an integrated circuit chip 21′ that includes the NCI firmware 40, wherein the NCI firmware 40 in the chip 21′ is connected to the near field (NFC) radio module 50, according to an embodiment of the present invention. The NFC handover request RF frame 60 from device 100B is received by the NFC antenna 11 of the near field (NFC) radio module 50 of device 100A and passes to the NCI firmware 40 in the integrated circuit chip 21′. The NCI firmware 40 extracts the payload data from the NFC handover request 60 and inserts it into the NCI data message 70, as shown in FIG. 2E. The payload data includes parameters indicating a proposed Connection Handover as Bluetooth™. The NCI firmware 40 passes the NCI data message 70 over the NFC controller interface (NCI) 13 to the NCI driver 30 in the integrated circuit chip. The functions of the transport layer firmware and the transport layer driver on respective sides of the NFC controller interface (NCI) 13, may be included in the integrated circuit chip. The CPU_{—}1 and CPU_{—}2 in processor 20 are programmed to recognize the Connection Handover request in the NCI data message 70 as designating Bluetooth™ as the alternate carrier. In response, the processor 20 passes a control signal over path 15 to the Bluetooth™ MAC 18A in the integrated circuit chip to modify the Bluetooth™ page scanning procedures for the Bluetooth™ radio module 18B when it searches for paging signals from device 100B.

FIG. 1D is an example embodiment of the wireless device A of FIG. 1C, illustrating the processor 20 as an integrated circuit chip 21″ that includes the NCI firmware 40 and the near field (NFC) radio 50, according to an embodiment of the present invention. The NFC handover request RF frame 60 from device 100B is received by the NFC antenna 11 of the near field (NFC) radio 50 in the integrated circuit chip 21″ and passes to the NCI firmware 40 in the integrated circuit chip 21″. The NCI firmware 40 extracts the payload data from the NFC handover request 60 and inserts it into the NCI data message 70, as shown in FIG. 2E. The payload data includes parameters indicating a proposed Connection Handover as Bluetooth™. The NCI firmware 40 passes the NCI data message 70 over the NFC controller interface (NCI) 13 to the NCI driver 30 in the integrated circuit chip. The functions of the transport layer firmware and the transport layer driver on respective sides of the NFC controller interface (NCI) 13, may be included in the integrated circuit chip. The CPU_{—}1 and CPU_{—}2 in processor 20 are programmed to recognize the Connection Handover request in the NCI data message 70 as designating Bluetooth™ as the alternate carrier. In response, the processor 20 passes a control signal over path 15 to the Bluetooth™ MAC 18A in the integrated circuit chip to modify the Bluetooth™ page scanning procedures for the Bluetooth™ radio module 18B when it searches for paging signals from device 100B.

An example embodiment of the invention includes an apparatus comprising:

means for transmitting, by a first device via an out-of-band short-range communication carrier, an indication to a second device that a carrier switch from the out-of-band short-range communication carrier to an in-band short-range communication carrier is desired;

means for receiving in response to the transmitted indication, a response from the second device via the out-of-band short-range communication carrier including an indication that the carrier switch from the out-of-band short-range communication carrier to the in-band short-range communication carrier is confirmed; and

means for modifying, by the first device, device detection procedure associated with the in-band short-range communication carrier to improve detection of paging signals on the in-band short-range communication carrier.

An example embodiment of the invention includes a apparatus comprising:

means for receiving, by a second device, an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and

means for modifying, by the second device, device detection procedure associated with the in-band short-range communication carrier to improve detection of paging signals from the first device, in an in-band communication connection.

An example embodiment of the invention includes a apparatus comprising:

means for transmitting, by an apparatus, an indication to a near field communication module to initiate an in-band short-range communication connection with a wireless device, using a wireless in-band short-range communication module;

means for receiving, by the apparatus, from the near field communication module, in response to the transmitted indication, a response from the wireless device that the in-band short-range communication connection is acceptable; and

means for modifying, by the apparatus, device detection procedure associated with the wireless in-band short-range communication module to improve detection of paging signals by the wireless in-band short-range communication module.

An example embodiment of the invention includes a apparatus comprising:

means for receiving, at an apparatus, an indication from a near field communication module to initiate short-range communication connection using a wireless short-range communication module; and

means for modifying, by the apparatus, device detection procedure associated with the wireless short-range communication module to improve detection of paging signals by the wireless short-range communication module.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
transmitting, by a first device via an out-of-band short-range communication carrier, an indication to a second device that a carrier switch from the out-of-band short-range communication carrier to an in-band short-range communication carrier is desired;
receiving in response to the transmitted indication, a response from the second device via the out-of-band short-range communication carrier including an indication that the carrier switch from the out-of-band short-range communication carrier to the in-band short-range communication carrier is confirmed; and
modifying, by the first device, device detection procedure associated with the in-band short-range communication carrier to improve detection of paging signals on the in-band short-range communication carrier.

2. The method of claim 1, wherein the indication of a carrier switch to an in-band carrier includes in-band communication connection parameters to adjust a paging procedure in the second device.

3. The method of claim 1, wherein the device detection procedure associated with the in-band short-range communication carrier is modified by at least one of increasing a duration of a page scanning window and decreasing a duration of a page scanning interval.

4. A method, comprising:
receiving, by a second device, an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and
modifying, by the second device, device detection procedure associated with the in-band short-range communication carrier to improve detection of paging signals from the first device, in an in-band communication connection.

5. The method of claim 4, wherein an indication of a carrier switch to an in-band carrier includes in-band communication connection parameters to adjust a paging scanning procedure in the second device.

6. The method of claim 4, wherein the device detection procedure associated with the in-band short-range communication carrier is modified by at least one of increasing a duration of a page scanning window and decreasing a duration of a page scanning interval.

7. An apparatus, comprising:
at least one processor;
at least one memory including computer program code;
the at least one memory and the computer program code configured to, with the at least one processor, cause the apparatus at least to:
transmit via an out-of-band short-range communication carrier, an indication to a second device that a carrier switch from the out-of-band short-range communication carrier to an in-band short-range communication carrier is desired;
receive in response to the transmitted indication, a response from the second device via the out-of-band short-range communication carrier including an indication that the carrier switch from the out-of-band short-range communication carrier to the in-band short-range communication carrier is confirmed; and
modify device detection procedure associated with the in-band short-range communication carrier to improve detection of paging signals on the in-band short-range communication carrier.

8. The apparatus of claim 7, wherein the indication of a carrier switch to an in-band carrier includes in-band communication connection parameters to adjust a paging procedure in the second device.

9. The apparatus of claim 7, wherein the device detection procedure associated with the in-band short-range communication carrier is modified by at least one of increasing a duration of a page scanning window and decreasing a duration of a page scanning interval.

10. The apparatus of claim 7, wherein, the out-of-band short-range carrier communication signals are based on one of Near Field Communication, Radio Frequency Identification, Infrared Data Association, or Ultra Wide Band communications protocol.

11. The apparatus of claim 7, wherein the apparatus and second devices use an NFC Forum connection handover protocol as the short-range carrier transport switch procedure for the carrier switch to an in-band carrier.

12. An apparatus, comprising:
at least one processor;
at least one memory including computer program code;
the at least one memory and the computer program code configured to, with the at least one processor, cause the apparatus at least to:
receive an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and
modify device detection procedure associated with the in-band short-range communication carrier to improve detection of paging signals from the first device, in an in-band communication connection.

13. The apparatus of claim 12, wherein an indication of a carrier switch to an in-band carrier includes in-band communication connection parameters to adjust a paging scanning procedure in the second device.

14. The apparatus of claim 12, wherein the device detection procedure associated with the in-band short-range communication carrier is modified by at least one of increasing a duration of a page scanning window and decreasing a duration of a page scanning interval.

15. The apparatus of claim 12, wherein, the out-of-band short-range carrier communication signals are based on one of Near Field Communication, Radio Frequency Identification, Infrared Data Association, or Ultra Wide Band communications protocol.

16. The apparatus of claim 12, wherein the first and second devices use an NFC Forum connection handover protocol as the short-range carrier transport switch procedure for the carrier switch to an in-band carrier.

17. A computer program product comprising computer executable program code recorded on a computer readable, non-transitory storage medium, the computer executable program code comprising:
code for transmitting, by a first device via an out-of-band short-range communication carrier, an indication to a second device that a carrier switch from the out-of-band short-range communication carrier to an in-band short-range communication carrier is desired;
code for receiving in response to the transmitted indication, a response from the second device via the out-of-band short-range communication carrier including an indication that the carrier switch from the out-of-band short-range communication carrier to the in-band short-range communication carrier is confirmed; and
code for modifying, by the first device, device detection procedure associated with the in-band short-range communication carrier to improve detection of paging signals on the in-band short-range communication carrier.

18. A computer program product comprising computer executable program code recorded on a computer readable, non-transitory storage medium, the computer executable program code comprising:
code for receiving, by a second device, an indication of a carrier switch to an in-band carrier, from a first device via an out-of-band short-range carrier communication connection, to enable a short-range carrier transport switch procedure to switch from the out-of-band short range carrier to the in-band carrier for communication between the devices; and
code for modifying, by the second device, device detection procedure associated with the in-band short-range communication carrier to improve detection of paging signals from the first device, in an in-band communication connection.

19. A method, comprising:
receiving, at an apparatus, an indication from a near field communication module to initiate short-range communication connection using a wireless short-range communication module; and
modifying, by the apparatus, device detection procedure associated with the wireless short-range communication module to improve detection of paging signals by the wireless short-range communication module.

20. The method of claim 19, further comprising determining by the apparatus, that the in-band short-range communication connection is acceptable before modifying the device detection procedure associated with the wireless short-range communication module.

21. An apparatus, comprising:
at least one processor;
at least one memory including computer program code;
the at least one memory and the computer program code configured to, with the at least one processor, cause the apparatus at least to:
receive an indication from a near field communication module to initiate short-range communication connection using a wireless short-range communication module; and
modify device detection procedure associated with the wireless short-range communication module to improve detection of paging signals by the wireless short-range communication module.

22. The apparatus of claim 21, wherein the at least one memory and the computer program code are further configured to, with the at least one processor, cause the apparatus at least to determine that the in-band short-range communication connection is acceptable before causing modifying the device detection procedure associated with the wireless short-range communication module.

23. A computer program product comprising computer executable program code recorded on a computer readable, non-transitory storage medium, the computer executable program code comprising:
code for receiving, at an apparatus, an indication from a near field communication module to initiate short-range communication connection using a wireless short-range communication module; and
code for modifying, by the apparatus, device detection procedure associated with the wireless short-range communication module to improve detection of paging signals by the wireless short-range communication module.
